(19) United States
(12) Patent Application Publication
(10) Pub. No.: US 2002/0198785 A1
(43) Pub. Date: Dec. 26, 2002

(54) Devices and methods for the suitability test in the electronic commerce transactions

(76) Inventor: Heon Chae, Seoul (KR)

Correspondence Address: BROWDY AND NEIMARK, P.L.L.C., 624 NINTH STREET, NW, SUITE 300, WASHINGTON, DC, 20001-5303, US

(21) Appl. No.: 09/795,521

(22) Filed: Mar. 1, 2001

(30) Foreign Application Priority Data
Mar. 29, 2000 (KR) 2000-16279

(51) Int. Cl. G06F 17/60

(52) U.S. Cl. 705/26

(57) ABSTRACT

The present invention relates to the suitability test in the e-Commerce context, the present invention, for a shopping mall playing an intermediary role in sales and purchases of products, comprises: a data recording means which models the information and images of various products provided by selling companies into two and three dimension images and registers such images; and a means which models and records two and three dimension images of the areas, where products will be applied, as indicated by purchasers and thus, through the present inventions a product to be purchased from the Internet shopping mall may be tested for suitability for a part of or the entire human body or for a space and, as a result, the purchaser may have a maximized satisfaction from the purchase of such product.

### BACKGROUND OF THE INVENTION

1. Field of the Invention

The present invention relates to a method of conducting electronic commerce. More specifically, the present invention relates to devices and methods for the suitability test in the e-Commerce context, whereby the object image of a product desired to be purchased on the web is tested for suitability for the area where such product is to be applied. The present invention simulates such suitability test by talking a picture, real time, on the web through PC cameras, digital cameras or video cameras installed on purchasers' PCs, and by immediately using images pictured in such maimer. It is intended that the suitability test of the present invention will increase the purchaser's satisfaction.

2. Prior Art

The Internet originated from the ARPANET which was the network constructed for the U.S. Department of Defense to share information for the purpose of military research. The Internet now connects numerous computer networks all over the world, conducting e-mail services, news broadcasting, file transfer, information transfer and search, and thus rendering itself to become an effective medium for accumulating and providing information. As the number of networks connected to the Internet and the number of Internet users increase, the commercial usage of the Internet is rapidly enlarged. In other words, increasing amount of goods and services are traded electronically through electronic methods such as electronic document transfers, for a portion of or the entire processes of the trade.

All of the persons who are engaged in the commercial activities in the actual world may participate in the electronic commerce (“e-Commerce”) in a like manner. In the e-Commerce context, commercial acts are made in the virtual world where there is no restriction regarding time or space. Also, the e-Commerce needs not involve any intermediate distributors. Thus, using the Internet, expenses for commercial transactions may be saved and the information on desired goods or on customers may conveniently and easily be obtained. Taking advantage of these strengths of the e-Commerce, companies may establish effective marketing strategies.

A conventional e-Commerce model, as illustrated in FIG. 1, comprises an Internet shopping mall operator site which is a virtual store selling goods or providing services (the “Shopping Mall (11)”), a seller (12) who establishes a store in the Shopping Mall (11) and displays products for sale, a purchaser (13) who obtains information on the services or products provided in the Shopping Mall (11) and purchases such services or goods based upon such information, a delivery company (14) which receives the relevant goods from the seller (12) based upon the delivery order from the Shopping Mall (11) and delivers such goods to the purchaser (13), and a credit card company (15) which pays for the purchase price for the goods purchased in the Shopping Mall (11) and charges such purchase price to the account of the purchaser (13).

The conventional e-Commerce model which has the above-described structure conducts commercial transactions in the following manner.

First, a purchaser (13) accesses the Internet from his or her own personal computer and finds product information provided in a certain Shopping Mall (11). During the search for products (e.g., accessories such as watches, rings, necklaces, earrings, glasses, clothes or shoes to be worn on bodies, or various interior goods, etc.), if the purchaser (13) finds a product that he or she desires to purchase, the purchaser (13) informs the Shopping Mall (11) of his or her intent to purchase and how the payment will be made (i.e., whether the purchaser (13) will pay for the product in cash, with a credit card or by the giro method).

As an illustration, if the purchaser (13) desires to pay for the product with a credit card, the purchaser (13) informs the Shopping Mall (11) of his or her financial identification numbers including the credit card number and the secret code. Then, the Shopping Mall (11) will issue a request for approval to the applicable credit card company (15) with the financial identification numbers that the purchaser (13) provided. When the credit card company (15) approves the credit card payment, the Shopping Mall (11) provides the purchase information to the seller (12) which established a store in the Shopping Mall (11) and is displaying its products. At the same time, the Shopping Mall (11) entrusts a delivery company (14) with the delivery of the purchased product to the purchaser (13).

The delivery company (14), pursuant to the delivery entrustment, receives the product from the seller (12), ships the product to the purchaser (13), and notifies the Shopping Mall (11) with the delivery confirmation information. Then, the Shopping Mall (11) requests the credit card company (15) to make the payment and, upon receiving the payment of such sales amount from the credit card company (15), the Shopping Mall (11) transfers the sales amount into the account of the seller (12). The credit card company (15) requests the purchaser (13) to pay for the product price, issuing the receipt for such payment, and receives the money from the purchaser (13) accordingly.

In the conventional Internet e-Commerce transactions, purchasers may conveniently and quickly purchase products without restrictions regarding time or space in the virtual space. However, the shapes, specifications or other information on the products provided in the Shopping Mall are transmitted to potential customers in two and three-dimensional images only. The conventional e-Commerce model does not provide ways to conduct any suitability test of the product to confirm that the product suits the purchaser's preferences or the object to which the product will be applied.

For example, a product purchased from a shopping mall, which may be accessories such as a pair of glasses, watch, ring, earring, or necklace, or may be a home interior product, may be proved by the purchaser, upon actual wearing or locating such product, to be unsuited for the body or the area where the product is intended to be used. In such case, the purchaser often disposes of the product or returns the product to the shopping mall.

For an illustration, it has been reported that more than 30% of the purchases made through the domestic Internet shopping malls are cancelled (or the goods are returned). The rate of returns is even greater in the United States.

Recognizing the problems described above, the present invention enables the suitability test in the e-Commerce context, whereby the object image of a product desired to be purchased on the web is tested for suitability for the area where such product is to be applied. The present invention simulates such suitability test by taking a picture, real time, on the web through PC cameras, digital cameras or video cameras installed on purchasers' PCs and by immediately using images pictured in such manner. Thus, the purchaser's satisfaction after the purchase gets increased and the purchase cancellation or product returns reduce accordingly. As a result, there may be less waste involved in the e-Commerce transactions.

In other words, the selling company or the shopping mall which operates the relevant web site provides on the web two and three dimensional image data regarding the products. The potential purchaser combines the image information on the interior space or on the body where the product is to be used, with the two and three dimensional image data of the product on the purchaser's PC, simulating the suitability test. For formation of three dimensional models of products, the two dimensional images are projected into the three dimensional models when the two dimensional images are combined with the three dimensional standard models from the database, changing the shapes in accordance with the figures of the two dimensional images. In these manners, through the substantial suitability test, the purchase demand of purchasers increases and the satisfaction regarding the purchased goods also increases.

### SUMMARY OF THE INVENTION

In order to achieve the above-described purposes, the present invention provides a device for the suitability test which, for a shopping mall playing an intermediary role in sales and purchases of products, comprises: a data recording means which models the information and images of various products provided by selling companies into two and three dimensional images and registers such images; and a means which models and records two and three dimension images of the areas where products will be applied as registered by purchasers.

Furthermore, the present invention provides the method for the suitability test which includes: a step in which a selling company takes a picture of each product, processes such picture into two and three dimensional data, and registers such data into a shopping mall; a step in which a purchaser takes a picture of the area where a desired product will be installed or used, processes such images into two and three dimension modeling data, and conducts the suitability on the purchasers PC; and a step in which the purchaser expresses intent, if any, to purchase the product.

### BRIEF DESCRIPTION OF THE DRAWINGS

FIG. 1 is a structure diagram illustrating a conventional electronic commerce model.

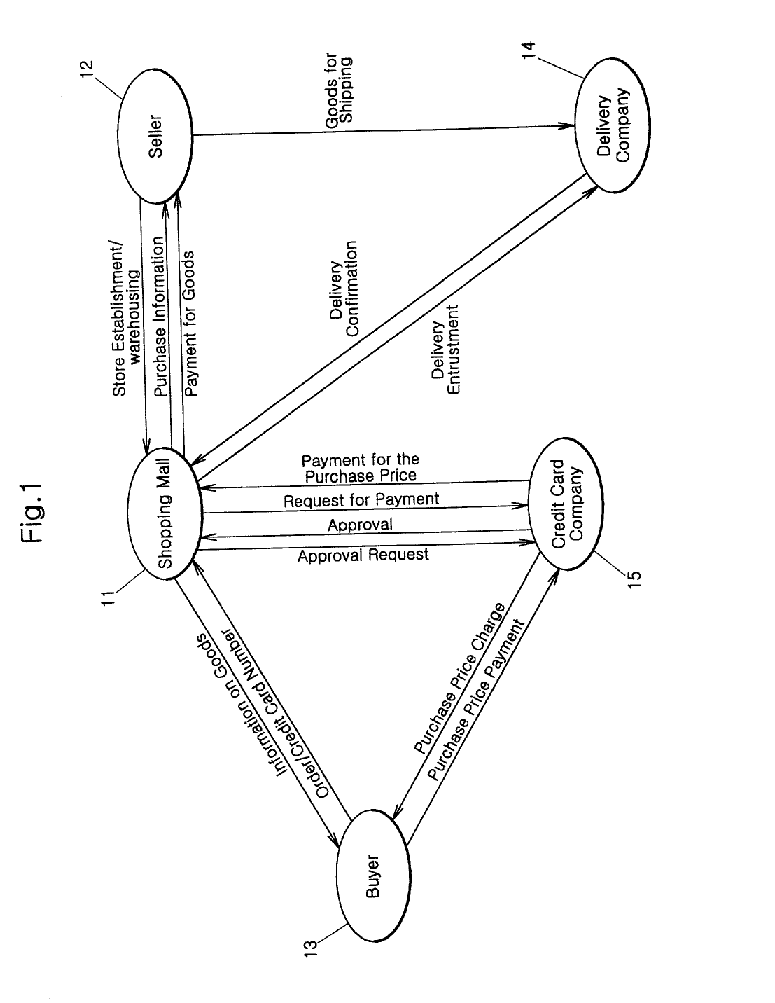

FIG. 2 is a diagram illustrating an electronic commerce model providing the suitability test according to the present invention.

FIG. 3 is a flow chart illustrating the process a selling company adopts to convert product images into a database according to the present invention.

FIG. 4 is a flow chart illustrating the process for purchasing products using the suitability test according to the present invention.

FIG. 5 is a flow chart illustrating the operation of the suitability test in the electronic commerce model according to the present invention.

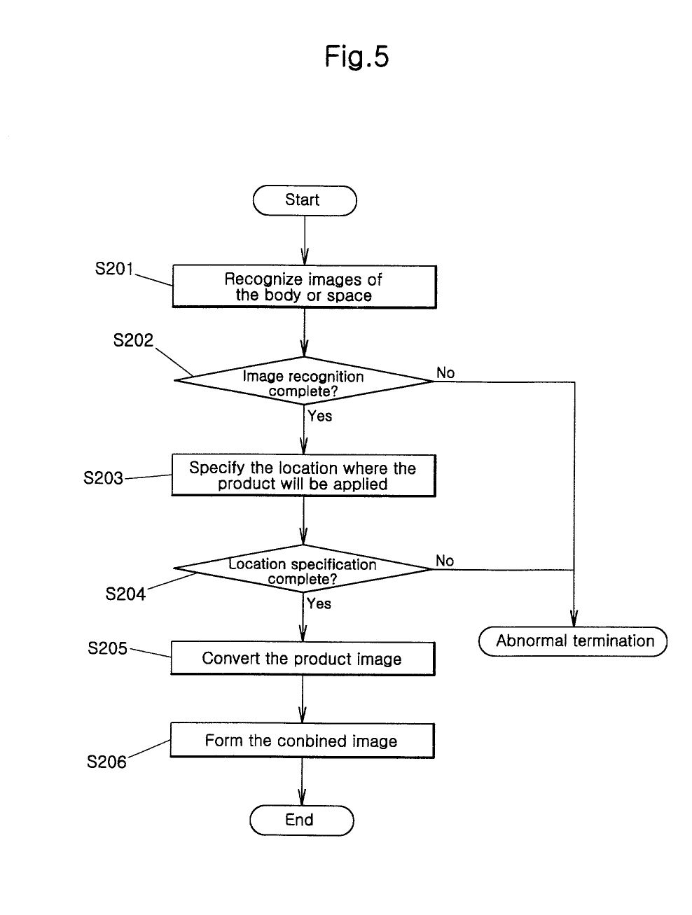

FIG. 6 is a diagram illustrating how the product information and the suitability test images are displayed on the purchaser's PC in the electronic commerce model according to the present invention.

### DETAILED DESCRIPTION OF THE PREFERRED EMBODIMENTS

In the following, the preferred embodiment of the present invention is explained in detail with references to the attached drawings.

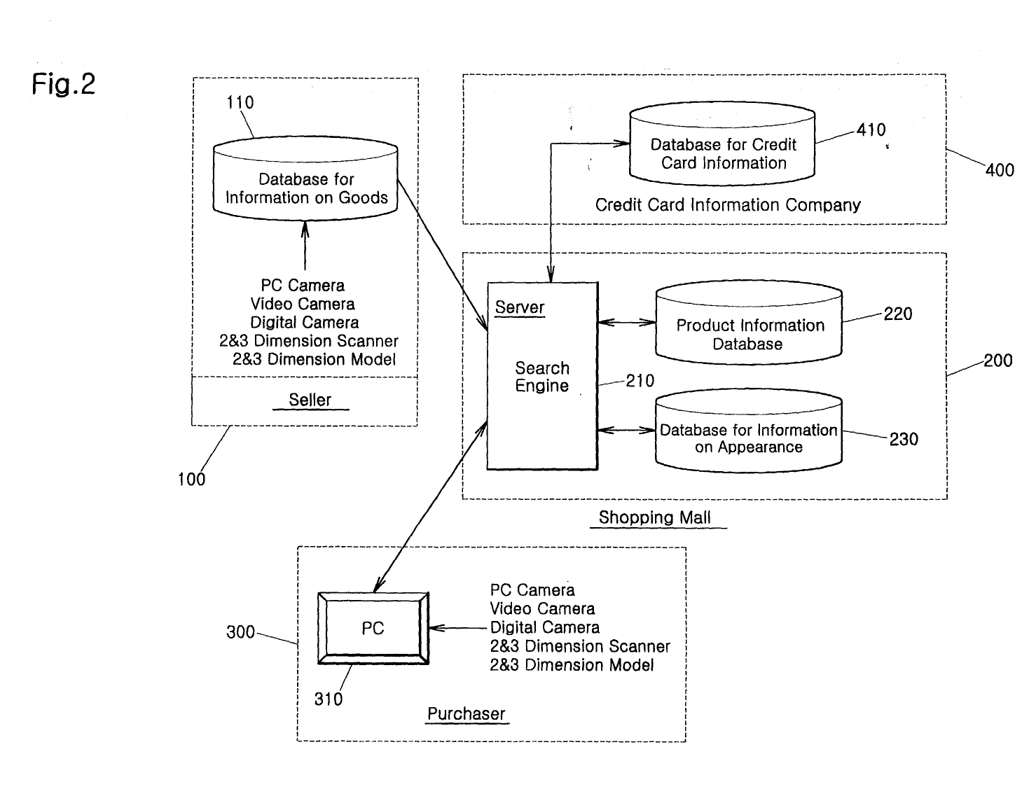

As illustrated in FIG. 2, the e-Commerce model providing the present invention's suitability test comprises the selling company (100), the shopping mall (200), the purchaser (300) and the credit card information company (400). The selling company (100) takes a picture of the products that it sells with a video recording means such as a PC camera, video camera, digital camera or two and three dimension scanner, processes such pictures into two and three dimensional model data using a certain algorithm, and records such data in the database for information on goods (110) installed in its web server, together with other information regarding the products, such as specifications, properties, usage, price and other features. The selling company (100) then provides the model data and information on the products which are recorded in the database for information on goods (110) to the shopping mall (200).

The shopping mall (200) is a virtual mall site administrated by an Internet shopping mall operator. The shopping mall (200) provides, through the web, the purchaser (300) with product information supplied by each selling company registered as a member with the shopping mall (200). Pursuant to the purchaser (300)'s request for the suitability test, the shopping mall (200) provides two and three dimensional image data on the requested product. If there is a purchase order, the shopping mall (200) arranges for the purchase of the product and ensures the delivery to the intended purchaser (300).

The purchaser (300) views the information regarding products as provided in the shopping mall (200), takes a picture, with a video recording means such as a PC camera, video camera, digital camera, or two and three dimensional scanner, of the home interior space or the applicable part of the body where the desired product is to be used. The purchaser (300) then processes such picture into two and three dimensional models using a certain algorithm selected in the purchaser's PC and combines the model data of the product provided in the shopping mall (200) with the purchasers own image model data in order to conduct the suitability test on the PC. Then, the purchaser (30) determines whether to purchase the product or not.

The credit card information company (400), using its credit card information database (410), analyzes the ability for payment and credit level of the purchaser (300) who wishes to purchase products from the shopping mall (200) and then notifies the shopping mall (200) of the result of such analysis.

The said shopping mall (200) further comprises: the search engine (210) which conducts general operations for the commercial transactions on the virtual space between the member-selling company (100) and the purchaser (300); the product information database (220) which contains two and three dimensional model data, general information such as specifications, features and prices regarding the products; and the database for image information (230) which contains the two and three dimensional image data of the products and the basic data provided by the purchaser (300) for the suitability test, to be performed on the purchaser's PC, with the two and three dimensional model image data of the applicable body part or interior space.

The suitability test of a product in the e-Commerce transaction model according to the present invention is conducted in the following manner.

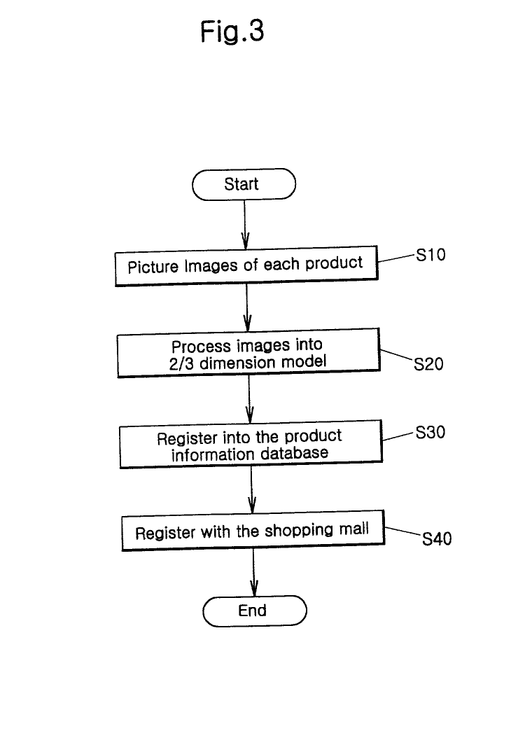

First of all, as illustrated in FIG. 3, the selling company (100) takes a picture of each product to be sold on its Internet shopping mall (200) using a video recording means such as a PC camera, video camera, digital camera or two/three dimensional scanner (S10). Then, such pictures are processed into two and three dimensional models through a certain predetermined algorithm (S20) and such models are recorded and registered in the database for information on products (110) which is installed in the web server (S30). The two and three dimensional model data on each product registered in the database for information on products (110) and other general information on products are registered in the product information database (220) of the shopping mall (200) (S40).

Where the products' two and three dimensional image model data and other general information are registered in the product information database (220) of the shopping mall (200) for each member-selling company (100), such products are sold to purchasers (300) pursuant to their requests as follows.

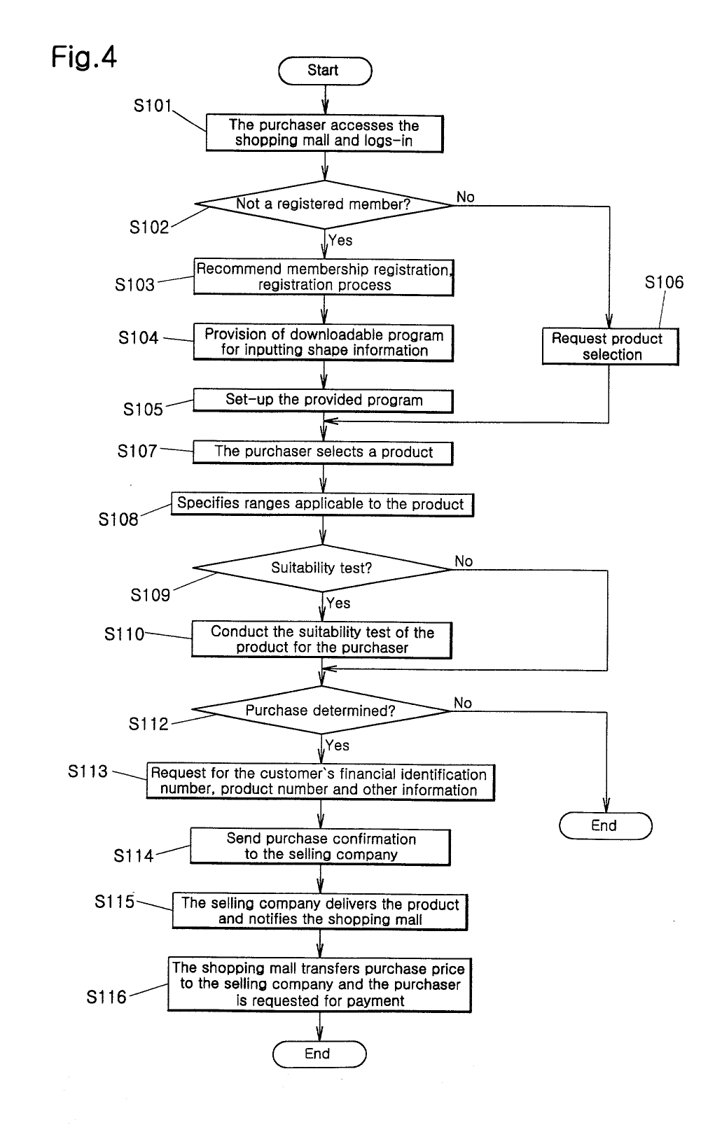

As illustrated in FIG. 4, when a purchaser (300) accesses the shopping mall (200) on the Internet and logs in (S101), the search engine (210) of the shopping mall (200) analyzes the log-in information to determine whether the user of the currently connected PC (310) is a registered member (S102).

If the user has not been registered, the PC (310) displays a message recommending subscription to the membership and guides the registration process through inputs of general information regarding the user, membership number and password (S103).

If the user of the connected PC (310) is a registered member of the shopping mall, the user is provided with a program for inputting the image information necessary for the suitability test of the product for the user's space or a body part where such product will be used (S104).

The user of the PC (310) with the downloaded program (the purchaser (300)) sets up such program in its PC (310) (S105).

Then, the user of the PC (310) (the purchaser (300)) selects a type of products, which may be accessories which may be rings, glasses, necklaces, watches or earrings, or home interior products, and specifies the price range, properties, size and etc., the search engine (210) of the shopping mall (200) accesses information on such selected product from the product information database (220) and displays the general information and images of the product on the PC (310) of the purchaser (300) (S107)(S108).

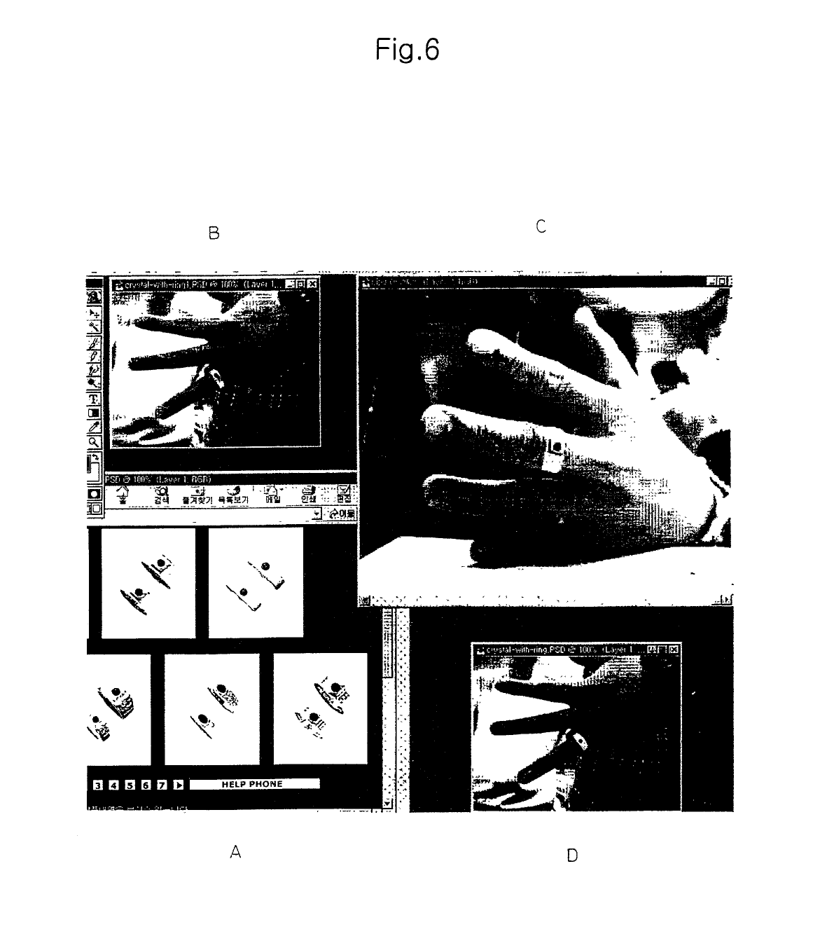

For example, if the purchaser (300) selects a ring, the shopping mall (200) accesses the two and three dimensional images of the ring, such as ‘A’ of the attached FIG. 6, and displays them to the purchaser (300).

Then, the search engine (210) of the shopping mall (200) asks whether the purchaser (300) wants to conduct the suitability test of the selected product for a body part or a home interior space as applicable. The search engine (210) then receives request for the suitability test from the purchaser (300) (S109).

If the purchaser (300)'s request for the suitability test is detected, the search engine (210) of the shopping mall (200) transmits the two and three dimensional model images of the product, which has been registered in the product information database (220) by the selling company, to the purchaser (300) through the web. The purchaser (300), using the video input means connected to the purchaser's PC, inputs a part of the body or a home interior space which is to be combined by the desired product. The purchaser (300) then converts such inputs into two and three dimensional modeling images and conduct the suitability test on the purchaser (300)'s PC by combining such converted images with the two and three dimensional model images of the product (S110).

As an example, in the event that the purchaser (300) selects a ring, the suitability test is conducted on the web by combining the selected ring with the images of the purchaser (300)'s finger as illustrated with ‘B,’ ‘C,’ and ‘D’ of FIG. 6.

After the purchaser (300)'s suitability test of the selected product for the area where the product is to be applied, the purchaser (300)'s decision for purchase is processed (S112). If, instead of a signal indicating the purchase decision, a signal demanding search for other products or a signal confirming the purchase cancellation is detected, the system considers that the purchaser (300) does not wish to purchase the selected product and terminates the applicable purchase action. If a signal indicating the decision to purchase is detected, the shopping mall (200) displays a message for selection of a payment method on the PC (310) of the purchaser.

If the purchaser (300) selects a payment by credit card, the search engine (210) of the shopping mall (200) requests the purchaser (300) to input financial identification numbers, number of the selected product, and other information required for credited purchase. After the purchaser (300)'s inputs of the financial identification numbers such as the credit card number, resident registration number, and the secret code, and other information such as the telephone number and the address to which the delivery is to be made, the search engine (210) of the shopping mall (200) transmits the purchaser (300)'s financial identification numbers to the credit card information company (400) for the credit assessment of the purchaser (300) (S113).

If the credit card information company (400) returns a negative credit assessment, notice stating that the selected product may not be purchased is given to the purchaser (300). If the credit assessment is positive, the search engine (210) of the shopping mall (200) issues a purchase confirmation to the selling company (100) so that the selected product may be delivered to the purchaser (300) (S114).

The selling company (100) which received a purchase confirmation from the shopping mall (200) delivers the selected product to the purchaser (300) using a predetermined way of delivery such as a delivery service or the postal service, and notifies the shopping mall (200) with the delivery confirmation. Then, the shopping mall (200) receives the purchase price from the credit card company and transfers it to the selling company (100) after subtracting certain fees, and the credit card company requests the purchaser (300) to pay for the selected product (S115) (S116).

In the above-described S102, if the user of the accessing PC (310) is determined to be a registered member, the search engine (210) of the shopping mall (200) provides the information on each product as provided by each selling company (100) and requests the purchaser (300) to select a product (S106). If the purchaser (300) makes such selection of a product, the suitability test, payment request, delivery entrustment, and request for the purchase price payment, etc. are conducted as explained in the foregoing.

In the said suitability test, the PC of the purchaser (300) receives the two and three images of the body part or the home interior space which were inputted through a video input means (S201) and determines whether the receipt of the images was conducted without error by detecting a inputted signal from the purchaser (300)(S202). If it is confirmed that the images were received without abnormality, the purchaser (300) is requested to specify the point where the selected product will be attached or installed (S203).

When the location where the product will be attached or installed is determined, the images of the selected product are converted into three dimensional images, and composite images are formed to test the suitability of the selected product for a part of or the entire body or the home interior space. Thus, the suitability test is conducted on the PC of the purchaser (300) (S204-S206).

For the suitability test described above, the two dimensional images of a part of or the entire body or the home interior space are captured from the two dimensional models recorded through a video input means such as a PC camera, video camera, digital camera or scanner. For a better suitability result of a product to be purchased, an instruction screen is provided on the PC (310) of the purchaser. The two dimensional model data of the selected product are retrieved from the product information database (220) and the resultant composite images are provided.

In order to raise the resolution of the pictures of the product, the product images are enlarged to the extent possible. In order to eliminate the sense of distance that appears in the pictures of the body or the home interior space and to save the images as the standard backgrounds, the pattern recognition method is used. In order to specify the part where the product is to be located, the present invention uses the pattern recognition method and a method indicating the width with two points for the location of the product.

Furthermore, in order to form a three dimensional image, the present invention uses the methods of forming a figure model by a laser scanner and projecting the two dimensional image onto such figure to form a realistic image. The shopping mall (200) uses the laser scanner to model the product selected by the purchaser (300) and the purchaser (300) uses the three dimensional data prepared in the manner described above and the product data to simulate the suitability test on the web.

The modeling of the product is also performed by using the laser scanner. Because it would take great efforts to make a 360 degree complete model, the present invention prepares the data only for the 120 degree which may be covered by one camera for simulation. For other less important parts, the standard model is used.

For the suitability simulation of an earring for the ear shape or for simulation of the hair figure, 360 degree's complete scanning is adopted to form the image. For the front and side views of the face, two dimensional images are projected and the selected hair style and hair color are applied thereto.

According to the present invention, the size of a pre-recorded standard three dimensional model may be adjusted according to the outline of a two dimensional figure, and the two dimensional images may be projected to become three dimensional models to form a realistic figure.

As illustrated in the foregoing, the present invention enables a purchaser who wishes to purchase a product from an Internet shopping mall to conduct the realistic suitability test on the purchaser's PC to see whether a selected product would be suitable for a part of or the entire body or the home interior space. Thus, the present invention, maximizes the consumer satisfaction from the purchase and promotes profits for the operation of Internet shopping malls by preventing cancellation of purchase orders or returns of the products.

What is claimed is

1. A device for the suitability test in the e-Commerce transactions through a shopping mall playing an intermediary role in sales and purchases of products, comprising:
a data recording means which models and registers image information of various products provided by selling companies into two and three dimension images;
a temporary recording means which temporarily stores two and three dimensional image data of the areas where products will be applied as indicated by purchasers;
a server which orchestrates the commercial transactions in the virtual space;
a credit card information company which provides the shopping mall with the purchaser's credit information; and
a video input means which is connected to the purchaser's PC.

2. A method for the suitability test in the e-Commerce transactions, comprising:
a step in which a selling company takes a picture of each product, processes such picture into two and three dimension data, and registers such data and other product information with a shopping mall;
a step in which the purchaser accesses the shopping mall and selects a product that the purchaser desires to purchase; and
a step in which the purchaser requests a suitability test, inputs a picture of the area where a desired product will be installed, processes such images into two and three dimension modeling data, conducts the suitability test of the two and three dimension images of the selected product, and then expresses its intent, if any, to purchase such product.

3. The method for the suitability test in the e-Commerce transactions according to claim 2, wherein:
the images of the product and the location, where the product will be installed, are pictured, real time, on the web by using a video input means such as a PC camera, video camera, digital camera, scanner, or etc., and the suitability test is conducted without storing the pictured image data.

4. The method for the suitability test in the e-Commerce transactions according to claim 2, wherein:
if the purchaser accessing the shopping mall is not a registered member, notice is given to such purchaser stating that the member registration is a prerequisite for purchase of products on the shopping mall; and
when the purchaser is registered as a member, a program, which enables the purchaser to conduct the suitability test on the purchaser's PC, is provided for downloading.

5. The method for the suitability test in the e-Commerce transactions according to claim 2, wherein the suitability test conducted on the purchaser's PC comprises:
a step in which two and three dimensional modeling images of the areas where the products will be applied are recognized;
a step in which the exact location at which the desired product is to be installed is recognized;
a step in which the desired product is converted into two and three dimensional modeling images; and
a step in which the suitability test is conducted by combining the image of the location where the product will be applied and the image of the product.

6. The method for the suitability test in the e-Commerce transactions according to claim 2, wherein:
the shopping mall may conduct duplex information transfers for provision of the suitability test with the graphic data or the image information of the body or home interior space of the purchaser and the two and three dimensional image modeling of the selected product.

7. The method for the suitability test in the e-Commerce transactions according to claim 2, wherein:
the suitability test adopts the pattern recognition method, which detects and digitalizes images of the boundaries of the substantial images of the applicable body or home interior space from the remainder of the images.

8. The method for the suitability test in the e-Commerce transactions according to claim 2, wherein:
the suitability test is conducted with a standard model for three dimensional simulation images.

9. The method for the suitability test in the e-Commerce transactions according to claim 2, wherein:
the suitability test adopts the image combination method by which the selected product is attached to the two and three dimensional graphic data provided by the purchaser.

10. The method for the suitability test in the e-Commerce transactions according to claim 2, wherein:
the suitability test is conducted by blurring the product images for better combination of the product images with the images provided by the purchaser.

11. The method for the suitability test in the e-Commerce transactions according to claim 2, wherein:
the suitability test conducts the image combination by automatic recognition of the size, direction, location, etc. of the product from the shape information provided by the purchaser.

12. The method for the suitability test in the e-Commerce transactions according to claim 2, wherein:
the image of the suitability test conducted by the purchaser is stored in the server, and
the image of the purchaser's suitability test stored in the said server may be brought in and used again later.
